(19) United States
(12) Patent Application Publication
(10) Pub. No.: US 2009/0089973 A1
(43) Pub. Date: Apr. 9, 2009

(54) FRICTION HINGE HAVING AN ELECTRICAL HEATING COMPONENT, AND METHOD OF CONTROLLING FRICTION FORCE IN A FRICTION HINGE

(75) Inventor: Shao-Ming Lee, Nan-Tou Hsien (TW)

Correspondence Address: FITZPATRICK CELLA HARPER & SCINTO, 30 ROCKEFELLER PLAZA, NEW YORK, NY, 10112, US

(73) Assignee: UNIVERSAL SCIENTIFIC INDUSTRIAL CO., LTD., Nan-Tou Hsien (TW)

(21) Appl. No.: 11/866,743

(22) Filed: Oct. 3, 2007

(51) Int. Cl. E05D 11/00; H05B 1/00

(52) U.S. Cl. 16/223; 219/201; 29/505

(57) ABSTRACT

A friction hinge includes a rotary unit, an expansion barrel, and an electrical heating component. The rotary unit includes a barrel contacting component. The expansion barrel has a thermal expansion coefficient larger than that of the barrel contacting component, and is shrink fitted on the barrel contacting component such that a friction force is present between the barrel contacting component and the expansion barrel. The electrical heating component is for applying heat to the expansion barrel that is sufficient to cause thermal expansion of the expansion barrel.

### BACKGROUND OF THE INVENTION

1. Field of the Invention

The invention relates to a friction hinge, more particularly to a friction hinge having an electrical heating component. This invention also relates to a method of controlling friction force in a friction hinge.

2. Description of the Related Art

As shown in FIGS. 1 and 2, a conventional friction hinge 7 comprises a fixing component 71 and a rotary component 72. The fixing component 71 has a fixing portion 711, a sleeve portion 712 extending from one end of the fixing portion 711, and a slit 713 formed at the sleeve portion 712. The rotary component 72 has a rotary portion 721 inserted rotatably into the sleeve portion 712, and a connecting portion 722 extending from one end of the rotary portion 721 opposite to the fixing portion 711. When assembling the conventional friction hinge 7, the sleeve portion 712 is crimped in radial directions, thereby resulting in a cross-sectional deformation thereof for tight contact with the rotary portion 721. Therefore, the rotary portion 721 can be positioned relative to the sleeve portion 712 via a large friction force therebetween.

However, wear between the rotary portion 721 and the sleeve portion 712 will gradually reduce the friction force therebetween, thereby resulting in eventual failure to position the rotary portion 721 relative to the sleeve portion 712, and a relatively short service life of the conventional friction hinge 7. While the influence of wear can be minimized by crimping the sleeve portion 712 harder when assembling the conventional friction hinge 7 for contacting the rotary portion 721 more tightly, this results in a too large friction force between the sleeve portion 712 and the rotary portion 721 that makes it difficult to rotate the rotary portion 721 relative to the sleeve portion 712.

### SUMMARY OF THE INVENTION

Therefore, an object of the present invention is to provide a friction hinge that is more durable, and that has a rotary part which can be easily rotated and positioned. Another object of the present invention is to provide a method of controlling friction force in a friction hinge.

According to one aspect of the present invention, a friction hinge of the present invention comprises a rotary unit, an expansion barrel, and an electrical heating component. The rotary unit includes a barrel contacting component. The expansion barrel has a thermal expansion coefficient larger than that of the barrel contacting component, and is shrink fitted on the barrel contacting component such that a friction force is present between the barrel contacting component and the expansion barrel. The electrical heating component is for applying heat to the expansion barrel that is sufficient to cause thermal expansion of the expansion barrel so as to adjust the friction force between the barrel contacting component and the expansion barrel.

According to another aspect of the present invention, there is provided a method of controlling friction force in a friction hinge. The friction hinge includes a rotary unit having a barrel contacting component, and an expansion barrel. The expansion barrel has a thermal expansion coefficient larger than that of the barrel contacting component, and is shrink fitted on the barrel contacting component such that a friction force is present between the barrel contacting component and the expansion barrel. The method comprises the step of: applying heat to the expansion barrel that is sufficient to cause thermal expansion of the expansion barrel.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional friction hinge;

FIG. 2 is a cross-sectional view of the conventional friction hinge;

FIG. 3 is an exploded perspective view of a preferred embodiment of a friction hinge according to the invention; and

FIG. 4 is a sectional view of the preferred embodiment.

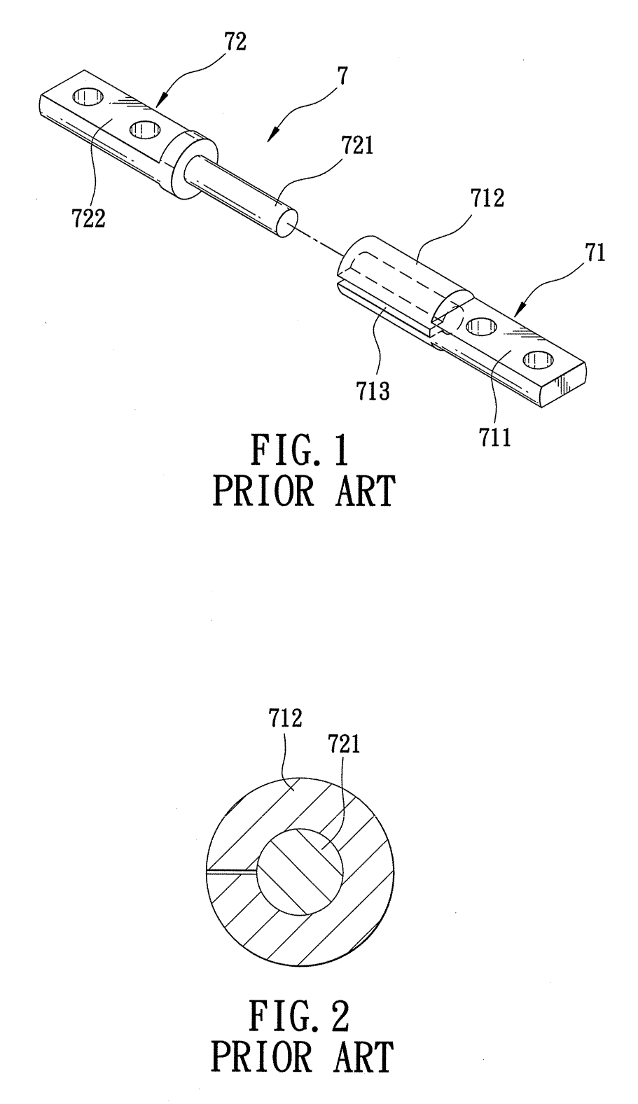

### DETAILED DESCRIPTION OF THE PREFERRED EMBODIMENT

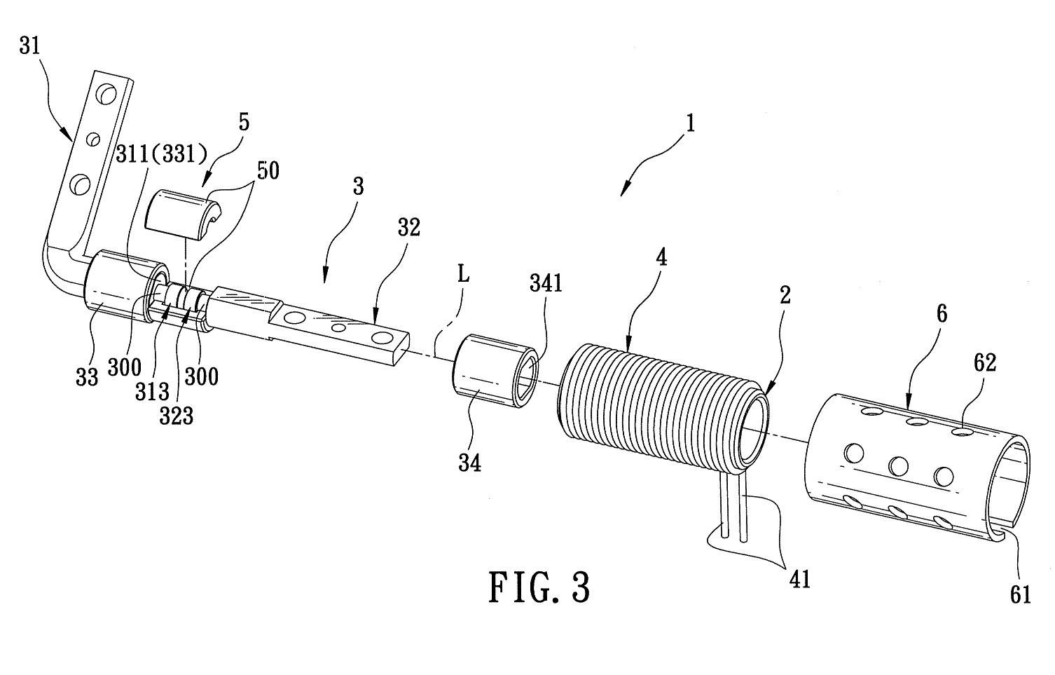

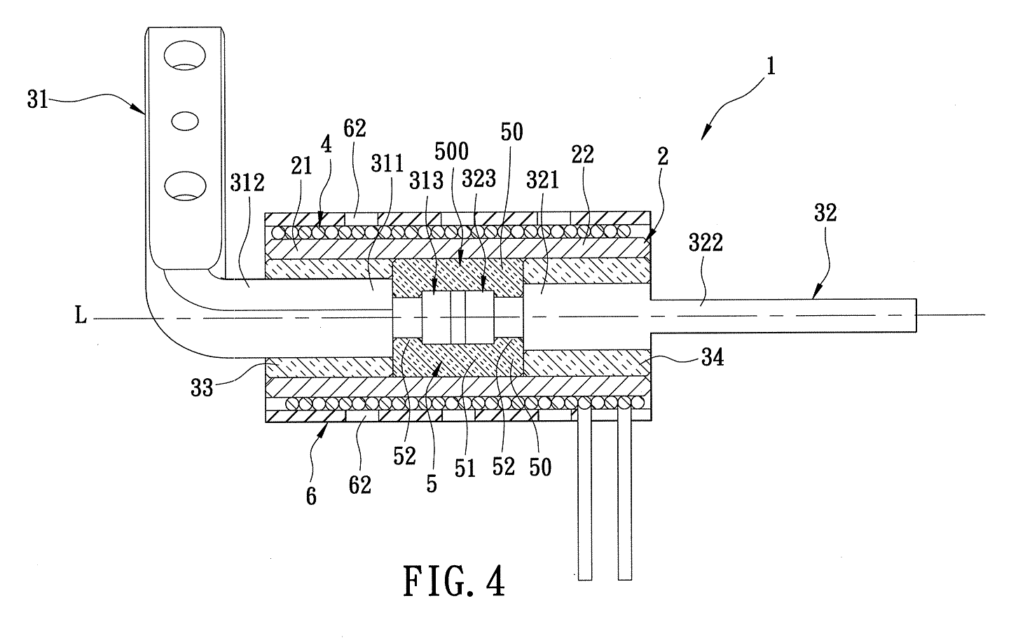

As shown in FIGS. 3 and 4, the preferred embodiment of a friction hinge 1 according to the present invention comprises a rotary unit 3, an expansion barrel 2, an electrical heating component 4, a positioning unit 5, and a protective sleeve 6.

The rotary unit 3 includes a first barrel contacting component 33 and a second barrel contacting component 34 that are tubular sleeves made of a heat insulating material, such as ceramic, a first rotary member 31, and a second rotary member 32. The first barrel contacting component 33 is sleeved non-rotatably on the first rotary member 31. The second barrel contacting component 34 is sleeved non-rotatably on the second rotary member 32.

The expansion barrel 2 extends along an axis (L), and has a thermal expansion coefficient larger than that of the first and second barrel contacting components 33, 34, and opposite first and second end portions 21, 22 respectively shrink fitted on the first and second barrel contacting components 33, 34 such that a friction force is present between the first barrel contacting component 33 and the expansion barrel 2, and that another friction force is present between the second barrel contacting component 34 and the expansion barrel 2.

The first rotary member 31 of the rotary unit 3 has a first coupling section 311 coupled non-rotatably to the first barrel contacting component 33, a first extending section 312 extending axially from one end of the first coupling section 311 opposite to the second rotary member 32 of the rotary unit 3 and extending outwardly of the expansion barrel 2, and a first engaging section 313 extending from the other end of the first coupling section 311. The second rotary member 32 of the rotary unit 3 has a second coupling section 321 coupled non-rotatably to the second barrel contacting component 34, a second extending section 322 extending axially from one end of the second coupling section 321 opposite to the first rotary member 31 and extending outwardly of the expansion barrel 2, and a second engaging section 323 extending from the other end of the second coupling section 321. The first coupling section 311 of the first rotary member 31 has a non-circular cross-section, and the first barrel contacting component 33 is formed with a through hole 331 having a shape that corresponds to the non-circular cross-section of the first coupling section 311. The second coupling section 321 of the second rotary member 32 also has a non-circular cross-section, and the second barrel contacting component 34 is formed with a through hole 341 having a shape that corresponds to the non-circular cross-section of the second coupling section 321.

The electrical heating component 4 is disposed to surround the expansion barrel 2 about the axis (L), and is for applying heat to the expansion barrel 2 that is sufficient to cause thermal expansion of the expansion barrel 2 so as to adjust the friction forces between the first and second barrel contacting components 33, 34 and the expansion barrel 2. The electrical heating component 4 has a pair of terminal ends 41 connected electrically to a switch (not shown), and may be an electric hot plate, a positive temperature coefficient heating element (PTC heating element), or a heating coil as in the preferred embodiment.

The positioning unit 5 is disposed for positioning the first and second rotary members 31, 32 of the rotary unit 3 relative to the axis (L), and includes a hollow positioning component 500 disposed in the expansion barrel 2. The positioning component 500 is formed from a pair of complementary halves 50, and has a connecting portion 51 with opposite axial ends and a pair of engaging portions 52 that extend respectively from the axial ends of the connecting portion 51. The first engaging section 313 of the first rotary member 31 extends into the positioning component 500 and engages rotatably one of the engaging portions 52. The second engaging section 323 of the second rotary member 32 also extends into the positioning component 500 and engages rotatably the other one of the engaging portions 52. In this embodiment, each of the first and second engaging sections 313, 323 of the first and second rotary members 31, 32 is formed with an annular recess 300 to receive the respective one of the engaging portions 52. The positioning unit 5 is made of ceramic in this embodiment.

The protective sleeve 6 is disposed to surround the electrical heating component 4 about the axis (L), and is formed with a set of heat dissipating holes 62 and a slit 61 that is parallel to the axis (L) and through which the terminal ends 41 of the electrical heating component 4 extend. The protective sleeve 6 is made of a resilient heat insulating material, such as artificial mica in the preferred embodiment.

In use, the first rotary member 31 of the rotary unit 3 is connected to a rotary object (not shown), while the second rotary member 32 of the rotary unit 3 is connected to a base (not shown). Since the expansion barrel 2 is shrink fitted on the first barrel contacting component 33 of the first rotary member 31, and since the first rotary member 31 is coupled non-rotatably to the first barrel contacting component 33, the rotary object can be positioned at a desired angle relative to the base by virtue of the friction force present between the first barrel contacting component 33 and the expansion barrel 2. When the electrical heating component 4 is activated to apply heat to the expansion barrel 2, the heat will cause thermal expansion of the expansion barrel 2, thereby resulting in reduction of the friction force between the first barrel contacting component 33 and the expansion barrel 2. At the same time, the first and second barrel contacting components 33, 34 insulate the first and second rotary members 31, 32 from the heat, and the rotary object can be rotated to a desired angle relative to the base. On the contrary, when the electrical heating component 4 is deactivated, the expansion barrel 2 will contract gradually to its original state before expansion so as to be shrink fitted once more on the first barrel contacting component 33, thereby positioning the rotary object relative to the base via the friction force between the first barrel contacting component 33 and the expansion barrel 2. Therefore, since the friction forces between the first and second barrel contacting components 33, 34 and the expansion barrel 2 are adjustable by virtue of the electrical heating component 4 and the expansion barrel 2, the first rotary member 31 can rotate easily relative to the second rotary member 32 without wear therebetween, thereby resulting in a longer service life of the friction hinge 1 of this invention.

It should be noted that the first and second barrel contacting components 33, 34 may be configured to extend along the respective one of the first extending section 312 of the first rotary member 31 of the rotary unit 3 and the second extending section 322 of the second rotary member 32 of the rotary unit 3 to insulate the rotary object and the base from the heat in other embodiments of this invention. Moreover, while the first and second barrel contacting component 33, 34 are sleeved respectively on the first and second rotary members 31, 32 in the preferred embodiment, the first and second rotary members 31, 32 may also serve as barrel contacting components in other embodiments of the invention when they are made of a heat insulating material.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A friction hinge comprising:
a rotary unit including a first barrel contacting component;
an expansion barrel having a thermal expansion coefficient larger than that of said first barrel contacting component, and shrink fitted on said first barrel contacting component such that a friction force is present between said first barrel contacting component and said expansion barrel; and
an electrical heating component for applying heat to said expansion barrel that is sufficient to cause thermal expansion of said expansion barrel.

2. The friction hinge as claimed in claim 1, wherein said first barrel contacting component is a tubular sleeve made of a heat insulating material, and wherein said rotary unit further includes a first rotary member that has said first barrel contacting component sleeved non-rotatably thereon.

3. The friction hinge as claimed in claim 2, wherein said first rotary member has a coupling section with a non-circular cross-section, and said first barrel contacting component is formed with a through hole having a snape that corresponds to the non-circular cross-section of said coupling section of said first rotary member.

4. The friction hinge as claimed in claim 1, wherein said expansion barrel extends along an axis, and said electrical heating component is disposed to surround said expansion barrel about the axis.

5. The friction hinge as claimed in claim 4, wherein said electrical heating component is a heating coil having a pair of terminal ends.

6. The friction hinge as claimed in claim 4, further comprising a protective sleeve that is disposed to surround said electrical heating component about the axis.

7. The friction hinge as claimed in claim 6, wherein said protective sleeve is formed with a slit parallel to the axis and a set of heat dissipating holes, and is made of a resilient heat insulating material.

8. The friction hinge as claimed in claim 2, wherein said rotary unit further includes a second barrel contacting component in a form of a tubular sleeve made of a heat insulating material, and a second rotary member that has said second barrel contacting component sleeved non-rotatably thereon, the thermal expansion coefficient of said expansion barrel being larger than that of said second barrel contacting component, said expansion barrel having opposite first and second end portions respectively shrink fitted on said first and second barrel contacting components, wherein a friction force is further present between said second barrel contacting component and said expansion barrel.

9. The friction hinge as claimed in claim 8, wherein said expansion barrel extends along an axis, said friction hinge further comprising a positioning unit for positioning said first and second rotary members of said rotary unit relative to the axis.

10. The friction hinge as claimed in claim 9, wherein:
said positioning unit includes a hollow positioning component disposed in said expansion barrel, and having a connecting portion with opposite axial ends, and a pair of engaging portions that extend respectively from said axial ends of said connecting portion;
said first rotary member of said rotary unit has a first coupling section coupled non-rotatably to said first barrel contacting component, a first extending section extending axially from one end of said first coupling section opposite to said second rotary member of said rotary unit and extending outwardly of said expansion barrel, and a first engaging section extending from the other end of said first coupling section into said positioning component and engaging rotatably one of said engaging portions of said positioning component; and
said second rotary member has a second coupling section coupled non-rotatably to said second barrel contacting component, a second extending section extending axially from one end of said second coupling section opposite to said first rotary member and extending outwardly of said expansion barrel, and a second engaging section extending from the other end of said second coupling section into said positioning component and engaging rotatably the other one of said engaging portions of said positioning component.

11. The friction hinge as claimed in claim 10, wherein each of said first and second engaging sections of said first and second rotary members is formed with an annular recess to receive the respective one of said engaging portions of said positioning component.

12. A method of controlling friction force in a friction hinge, the friction hinge including
a rotary unit having a barrel contacting component, and
an expansion barrel having a thermal expansion coefficient larger than that of the barrel contacting component, and shrink fitted on the barrel contacting component such that a friction force is present between the barrel contacting component and the expansion barrel, said method comprising the step of:
applying heat to the expansion barrel that is sufficient to cause thermal expansion of the expansion barrel so as to adjust the friction force between the barrel contacting component and the expansion barrel.

13. The method of claim 12, wherein heat is applied to the expansion barrel using an electrical heating component.

14. The method of claim 13, wherein the electrical heating component is a heating coil disposed to surround the expansion barrel.

15. A method of making a friction hinge, comprising the steps of:
shrink-fitting an expansion barrel on a barrel contacting component of a rotary unit such that a friction force is present between the barrel contacting component and the expansion barrel, the expansion barrel having a thermal expansion coefficient larger than that of the barrel contacting component; and
disposing an electrical heating component on the expansion barrel, wherein the electrical heating component is operable to apply heat to the expansion barrel that is sufficient to cause thermal expansion of the expansion barrel so as to adjust the friction force between the barrel contacting component and the expansion barrel.
